(19) United States
(12) Patent Application Publication
(10) Pub. No.: US 2024/0297965 A1
(43) Pub. Date: Sep. 5, 2024

(54) SCREEN READER GUIDANCE FOR QUICK RESPONSE (QR) SCANNING

(71) Applicant: Sony Group Corporation, Tokyo (JP)

(72) Inventor: Sabrina Norton, San Diego, CA (US)

(73) Assignee: Sony Group Corporation, Tokyo (JP)

(21) Appl. No.: 18/116,070

(22) Filed: Mar. 1, 2023

(51) Int. Cl. H04N 7/18; G06K 7/10; G06K 7/14; H04M 1/72409; H04M 1/72481

(52) U.S. Cl. CPC H04N 7/185; G06K 7/10722; G06K 7/1417; H04M 1/72409; H04M 1/72481

(57) ABSTRACT

Implementations generally relate to setting up a television. In some implementations, a method includes initiating a setup procedure of a television. The method further includes displaying a code on a television screen of the television for a user to scan. The method further includes instructing the user to open a code scanner on a camera device associated with the user. The method further includes determining that the user is vision impaired. The method further includes facilitating the user in scanning the code on the television screen with the camera device.

### BACKGROUND

A quick response (QR) code is a type of machine-readable optical label or barcode that stores information and can be read by a digital device, such as a cell phone. The information may be associated with an item to which it is attached. For example, such information may include entity information, such a website URL, contact information, etc.

### SUMMARY

Implementations generally relate to setting up a television. In some implementations, a system includes one or more processors, and includes logic encoded in one or more non-transitory computer-readable storage media for execution by the one or more processors. When executed, the logic is operable to cause the one or more processors to perform operations including: initiating a setup procedure of a television; displaying a code on a television screen of the television for a user to scan; instructing the user to open a code scanner on a camera device associated with the user; determining that the user is vision impaired; and facilitating the user in scanning the code on the television screen with the camera device.

With further regard to the system, in some implementations, the code is a quick response (QR) code. In some implementations, the camera device is integrated with a smartphone. In some implementations, to facilitate the user, the instructions when executed are further operable to cause the one or more processors to perform operations including providing feedback to the user with regard to scanning the code on the television screen. In some implementations, the logic when executed is further operable to cause the one or more processors to perform operations including configuring the code on the television, where the configuring includes positioning the code in a central region of the display screen of the television. In some implementations, the logic when executed is further operable to cause the one or more processors to perform operations including configuring the code on the television, where the configuring includes enlarging the code on the display screen of the television. In some implementations, the logic when executed is further operable to cause the one or more processors to perform operations including: establishing communication between the television and the camera device of the user; and detecting that the camera device has properly scanned the code.

In some implementations, a non-transitory computer-readable storage medium with program instructions thereon is provided. When executed by one or more processors, the instructions are operable to cause the one or more processors to perform operations including: initiating a setup procedure of a television; displaying a code on a television screen of the television for a user to scan; instructing the user to open a code scanner on a camera device associated with the user; determining that the user is vision impaired; and facilitating the user in scanning the code on the television screen with the camera device.

With further regard to the computer-readable storage medium, in some implementations, the code is a QR code. In some implementations, the camera device is integrated with a smartphone. In some implementations, to facilitate the user, the instructions when executed are further operable to cause the one or more processors to perform operations including providing feedback to the user with regard to scanning the code on the television screen. In some implementations, the instructions when executed are further operable to cause the one or more processors to perform operations including configuring the code on the television, where the configuring includes positioning the code in a central region of the display screen of the television. In some implementations, the instructions when executed are further operable to cause the one or more processors to perform operations including configuring the code on the television, where the configuring includes enlarging the code on the display screen of the television. In some implementations, the instructions when executed are further operable to cause the one or more processors to perform operations including: establishing communication between the television and the camera device of the user; and detecting that the camera device has properly scanned the code.

In some implementations, a method includes: initiating a setup procedure of a television; displaying a code on a television screen of the television for a user to scan; instructing the user to open a code scanner on a camera device associated with the user; determining that the user is vision impaired; and facilitating the user in scanning the code on the television screen with the camera device.

With further regard to the method, in some implementations, the code is a QR code. In some implementations, the camera device is integrated with a smartphone. In some implementations, to facilitate the user, the method further includes providing feedback to the user with regard to scanning the code on the television screen. In some implementations, the method further includes configuring the code on the television, where the configuring includes positioning the code in a central region of the display screen of the television. In some implementations, the method further includes configuring the code on the television, where the configuring includes enlarging the code on the display screen of the television.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example media environment, which may be used for some implementations described herein.

FIG. 2 is an example flow diagram for setting up a television, according to some implementations.

FIG. 3 is a block diagram of an example network environment, which may be used for some implementations described herein.

FIG. 4 is a block diagram of an example computer system, which may be used for some implementations described herein.

### DETAILED DESCRIPTION

Implementations described herein enable and facilitate the setting up a television. People who are vision-impaired (e.g., blind, low vision, etc.) have a difficult time scanning quick response (QR) codes when they are unable to focus camera on the QR code due to lack of sight. Implementations provide guidance to a user trying to take a photo, specifically, to a user trying to find a QR code within the camera frame. This makes some onscreen setup processes very difficult due to an inability to quickly link a mobile device to a television (TV) account. Implementations described address these issues.

As described in more detail herein, in various implementations, a system initiates a setup procedure of a television. The system further displays a code on a television screen of the television for a user to scan. The system further instructs the user to open a code scanner on a camera device associated with the user. The system further determines that the user is vision impaired. The system further facilitates the user in scanning the code on the television screen with the camera device.

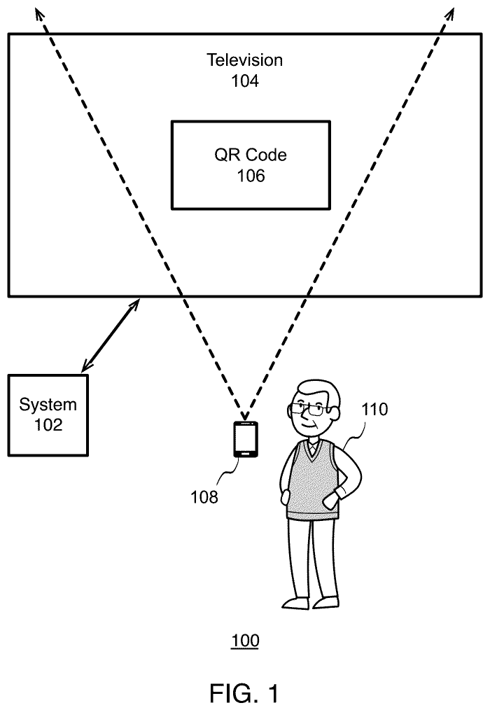

FIG. 1 illustrates a block diagram of an example media environment 100, which may be used for some implementations described herein. In some implementations, media environment 100 includes a system 102, which communicates with a television (TV) 104.

As described in more detail herein, in various implementations, system 102 displays a QR code 106 on the display screen of television 102. Also shown is a client device 108. In this particular example implementation, client device 108 is a smartphone. In other implementations, client device 108 may be any other type of client device, such as TV remote controller, a tablet, etc. Also shown is a user 110.

As described in more detail herein, in various implementations, when QR code 106 is displayed on TV 104, user 110 may use client device 108 to capture QR code 106. Once captured, system 102 may send instructions to user 110 for configuring the settings of television 104. In various implementations, television 104 may communicate with user 110 via client device 108.

While system 102 is shown separately from TV 104, in various implementations, system 102 may also be integrated with TV 104. If separate from TV 104, system 102 may reside in other devices or may be located in other locations (e.g., in the cloud).

In other implementations, media environment 100 may not have all of the components shown and/or may have other elements including other types of elements instead of, or in addition to, those shown herein. In the various implementations described herein, a processor of television 104 may cause the elements described herein (e.g., settings, commands, messages, user preferences, etc.) to be displayed in a user interface on one or more display screens.

While system 102 performs implementations described herein, in other implementations, any suitable component or combination of components associated with system 102 or any suitable processor or processors associated with system 102 may facilitate performing the implementations described herein.

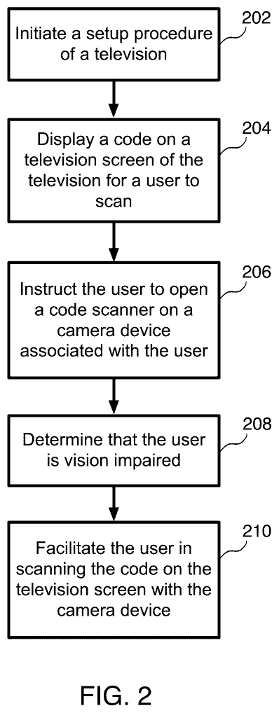

FIG. 2 is an example flow diagram for setting up a television, according to some implementations. Referring to both FIGS. 1 and 2, a method is initiated at block 202, where a system such as system 102 initiates a setup procedure of a TV. A TV may be set up, for example, when the TV is newly purchased. In some implementations, the system may initiate a TV setup procedure when the user powers the TV on. If the user turns the TV on and it has previously set up, the system may enable the user to navigate to a menu to manually start a new set up process.

At block 204, the system displays a code on a television screen of the television for a user to scan. In various implementations, the code is a quick response (QR) code. In some implementations, the system provides a short uniform resource locator (URL) along with the QR code. In some implementations, the URL is a short URL. This provides the user with scanning options for receiving guidance for setting up the TV.

In some implementations, the system may provide the QR code on an alternative display or an additional display, such as on the screen of the user's smartphone. In some scenarios, the QR code may be already printed on the TV package or printed on a piece of paper in the package. There may be some scenarios where the system guides the user to scan a QR code on one of these alternative locations. Having the code in different locations provides the user with more scanning options for receiving guidance for setting up the TV.

At block 206, the system instructs the user to open a code scanner on a camera device associated with the user. The code scanner is an application on the camera device that enables the camera device to capture or scan a code such as a QR code. In various implementations, the camera device is integrated with a smartphone. In some implementations, the camera device may be integrated with other types of devices such as tablets, etc. In various implementations, the system may instruct the user to open the code scanner by text on the TV screen and/or by audio instructions. For example, the system may display the instruction on the TV screen. In some implementations, if there is a delay in the scanning of the code, the system may then provide instructions by voice via the TV speakers. Example implementations directed to auditory or voice instructions are described below in connection with block 208.

At block 208, the system determines that the user is vision impaired. In some implementations, the system may determine that the user is vision impaired based on a user profile associated with the user. For example, the system may analyze a user profile of the user. The system searches for any data that indicates vision impairment to determine if the user is vision impaired.

In some implementations, the system may determine that the user is vision impaired based on a time delay of user response after being prompted to scan the code. For example, if the system instructs the user to capture the QR code displayed on the TV screen, and if there is a significant time delay, the system may initiate a screen reader application. The time delay may be considered significant based on a predetermined time period. The length predetermined time period (e.g., after 15 seconds, 30 seconds, etc.) may vary, and will depend on the particular implementation. In some implementations, if the system automatically initiates a screen reader, the system may modify a tag or status of the user as being hearing impaired. Such a designation may cause the system to automatically initiate the screen reader as needed for other TV configuration procedures. The system enables the user to change the designation as desired by the user.

At block 210, the system facilitates the user in scanning the code on the television screen with the camera device. In various implementations, the system facilitates the user by providing feedback to the user with regard to scanning the code on the television screen. In various implementations, the system provides feedback or guidance to the user by voice via the TV speakers. For example, the system may utilize screen reader techniques to guide the user 110 when scanning QR code 106. The system may provide the screen reading guidance via a device presenting QR code 106, such as TV 104. In some implementations, to facilitate/guide the user, the system may indicate the size and general location of the code on the screen of TV 104 (e.g., “A QR code is displayed on the screen,” “The code is large,” “The code is located in the center of the TV screen,” etc.).

In some implementations, the system may provide guidance by voice via client device 108. For example, the system may ask the user to hold up client device 108 to capture QR code 106. When the user aims the camera of client device 108 toward TV 104, the system may indicate to the user when the camera of client device 108 captures at least a portion of TV 104. The system then guides the user to direct the camera of client device 108 to the general location of QR code 106 on the screen of TV 104.

In some implementations, when the camera of client device 108 captures at least a portion of QR code 106, the system then guides the user to direct the camera such that QR code 106 is centered in the frame of the camera. In various implementations, the system may provide guidance such as raising the camera, lowering the camera, panning the camera to the left or to the right, freezing movement to capture QR code 106, etc. In various implementations, the scanning of the QR code initiates further instructions. For example, the system may display an on-screen set up processes for setting up the television, in response to the capturing of the QR code.

As indicated above, in various implementations, the system may provide the guidance and instructions to the user by voice via the TV speakers. In some implementations, the system may enable the smartphone of the user to provide guidance and instructions by voice via the smartphone speakers. The system may also provide instructions by electronic text for the user on the smartphone, where the smartphone reads the text to the user. In some implementations, the system may provide audio or voice instructions.

In various implementations, the system configures the code (e.g., QR code) on the TV such that the code is positioned in a central region of the screen of the TV. The system may position anywhere on the screen based on the particular implementation. In various implementations, the system configures the code on the TV such that code is enlarged on the display screen of the TV. The particular positioning and size of the code may vary, depending on the particular implementation.

In some implementations, the system provides interactive feedback that directionally guides the user where to aim the camera device to capture the code. For example, as indicated above, the system may provide interactive feedback that indicates the general location and size of the code on the screen of the television (e.g., “QR code is located in the center of the screen,” “The QR code is large,” etc.). In some implementations, the system provides interactive feedback that guides the user to centering the code within a camera frame of a camera device of the user. These examples of guidance enable users to more efficiently scan QR codes.

In some implementations, if the system notices that the code is partially cut off or out of focus, the system instructs the user to properly center and focus on the QR code to scan. For example, the system may guide the user to move the camera in a particular direction (e.g., up, down, left, right, etc.) with further guidance (e.g., stop, take picture, etc.). In some implementations, the system provides interactive feedback that describes other content the on-screen.

In some implementations, if the QR code is in the frame when taking a photo but partially blocked or blurry, the system may provide interactive feedback to the user, such as “Person on left side of frame” or “tap camera screen to focus.”

In various implementations, the system establishes communication between the TV and the camera device of the user. The camera device may be the smartphone of the user, for example. The user then holds the camera/smartphone up to capture the code. The system then detects that the camera device has properly scanned the code. In some implementations, the system sends the code from the television to a mobile device. The system then displays the code on the mobile device for capture.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While implementations have been described herein in the context of QR codes, these implementations may have other applications. For example, in various implementations, the system may guide a user in a general camera application for taking photos. The system may help a user to center and focus on a person or object in the camera frame when taking a photo. For example, when taking a photo, the system may provide interactive feedback to the user, such as “A person is on the left side of the frame.” or “Tap the camera screen to focus,” etc.

Implementations described herein provide various benefits. For example, implementations assist a vision impaired user in setting up a TV. Implementations described herein also assist a user in capturing a QR code displayed on the TV using a client device such as a smartphone.

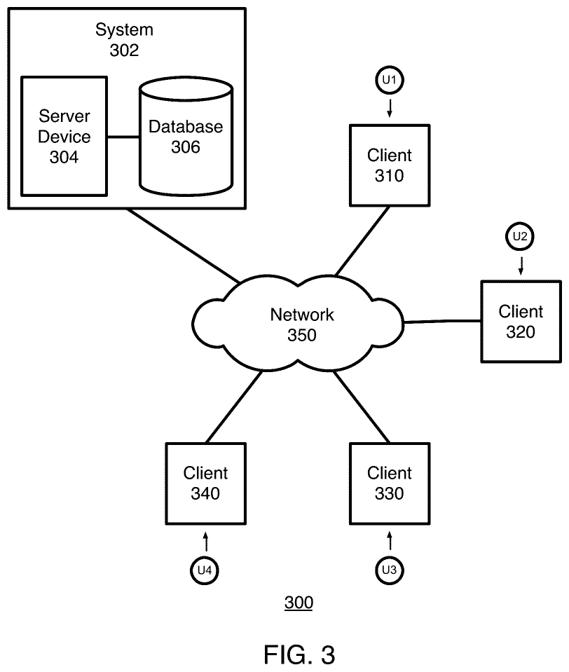

FIG. 3 is a block diagram of an example network environment 300, which may be used for some implementations described herein. In some implementations, network environment 300 includes a system 302, which includes a server device 304 and a database 306. For example, system 302 may be used to implement system 102 of FIG. 1, as well as to perform implementations described herein. Network environment 300 also includes client devices 310, 320, 330, and 340, which may communicate with system 302 and/or may communicate with each other directly or via system 302. Network environment 300 also includes a network 350 through which system 302 and client devices 310, 320, 330, and 340 communicate. Network 350 may be any suitable communication network such as a Wi-Fi network, Bluetooth network, the Internet, etc.

For ease of illustration, FIG. 3 shows one block for each of system 302, server device 304, and network database 306, and shows four blocks for client devices 310, 320, 330, and 340. Blocks 302, 304, and 306 may represent multiple systems, server devices, and network databases. Also, there may be any number of client devices. In other implementations, environment 300 may not have all of the components shown and/or may have other elements including other types of elements instead of, or in addition to, those shown herein.

While server device 304 of system 302 performs implementations described herein, in other implementations, any suitable component or combination of components associated with system 302 or any suitable processor or processors associated with system 302 may facilitate performing the implementations described herein.

In the various implementations described herein, a processor of system 302 and/or a processor of any client device 310, 320, 330, and 340 cause the elements described herein (e.g., information, etc.) to be displayed in a user interface on one or more screens.

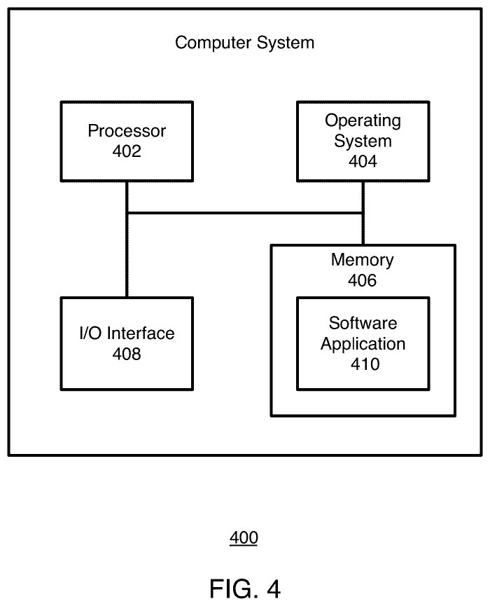

FIG. 4 is a block diagram of an example computer system 400, which may be used for some implementations described herein. For example, computer system 400 may be used to implement server device 304 of FIG. 3 and/or system 102 of FIG. 1, as well as to perform implementations described herein. In some implementations, computer system 400 may include a processor 402, an operating system 404, a memory 406, and an input/output (I/O) interface 408. In various implementations, processor 402 may be used to implement various functions and features described herein, as well as to perform the method implementations described herein. While processor 402 is described as performing implementations described herein, any suitable component or combination of components of computer system 400 or any suitable processor or processors associated with computer system 400 or any suitable system may perform the steps described. Implementations described herein may be carried out on a user device, on a server, or a combination of both.

Computer system 400 also includes a software application 410, which may be stored on memory 406 or on any other suitable storage location or computer-readable medium. Software application 410 provides instructions that enable processor 402 to perform the implementations described herein and other functions. Software application may also include an engine such as a network engine for performing various functions associated with one or more networks and network communications. The components of computer system 400 may be implemented by one or more processors or any combination of hardware devices, as well as any combination of hardware, software, firmware, etc.

For ease of illustration, FIG. 4 shows one block for each of processor 402, operating system 404, memory 406, I/O interface 408, and software application 410. These blocks 402, 404, 406, 408, and 410 may represent multiple processors, operating systems, memories, I/O interfaces, and software applications. In various implementations, computer system 400 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (Saas) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
initiating a setup procedure of a television;
displaying a code on a television screen of the television for a user to scan;
instructing the user to open a code scanner on a camera device associated with the user;
determining that the user is vision impaired; and
facilitating the user in scanning the code on the television screen with the camera device.

2. The system of claim 1, wherein the code is a quick response (QR) code.

3. The system of claim 1, wherein the camera device is integrated with a smartphone.

4. The system of claim 1, wherein, to facilitate the user, the instructions when executed are further operable to cause the one or more processors to perform operations comprising providing feedback to the user with regard to scanning the code on the television screen.

5. The system of claim 1, wherein the logic when executed is further operable to cause the one or more processors to perform operations comprising configuring the code on the television, and wherein the configuring comprises positioning the code in a central region of the display screen of the television.

6. The system of claim 1, wherein the logic when executed is further operable to cause the one or more processors to perform operations comprising configuring the code on the television, and wherein the configuring comprises enlarging the code on the display screen of the television.

7. The system of claim 1, wherein the logic when executed is further operable to cause the one or more processors to perform operations comprising:
establishing communication between the television and the camera device of the user; and
detecting that the camera device has properly scanned the code.

8. A non-transitory computer-readable storage medium with program instructions stored thereon, the program instructions when executed by one or more processors are operable to cause the one or more processors to perform operations comprising:
initiating a setup procedure of a television;
displaying a code on a television screen of the television for a user to scan;
instructing the user to open a code scanner on a camera device associated with the user;
determining that the user is vision impaired; and
facilitating the user in scanning the code on the television screen with the camera device.

9. The computer-readable storage medium of claim 8, wherein the code is a quick response (QR) code.

10. The computer-readable storage medium of claim 8, wherein the camera device is integrated with a smartphone.

11. The computer-readable storage medium of claim 8, wherein, to facilitate the user, the instructions when executed are further operable to cause the one or more processors to perform operations comprising providing feedback to the user with regard to scanning the code on the television screen.

12. The computer-readable storage medium of claim 8, wherein the instructions when executed are further operable to cause the one or more processors to perform operations comprising configuring the code on the television, and wherein the configuring comprises positioning the code in a central region of the display screen of the television.

13. The computer-readable storage medium of claim 8, wherein the instructions when executed are further operable to cause the one or more processors to perform operations comprising configuring the code on the television, and wherein the configuring comprises enlarging the code on the display screen of the television.

14. The computer-readable storage medium of claim 8, wherein the instructions when executed are further operable to cause the one or more processors to perform operations comprising:
establishing communication between the television and the camera device of the user; and
detecting that the camera device has properly scanned the code.

15. A computer-implemented method comprising:
initiating a setup procedure of a television;
displaying a code on a television screen of the television for a user to scan;
instructing the user to open a code scanner on a camera device associated with the user;
determining that the user is vision impaired; and
facilitating the user in scanning the code on the television screen with the camera device.

16. The method of claim 15, wherein the code is a quick response (QR) code.

17. The method of claim 15, wherein the camera device is integrated with a smartphone.

18. The method of claim 15, wherein, to facilitate the user, the method further comprises providing feedback to the user with regard to scanning the code on the television screen.

19. The method of claim 15, further comprising configuring the code on the television, and wherein the configuring comprises positioning the code in a central region of the display screen of the television.

20. The method of claim 15, further comprising configuring the code on the television, and wherein the configuring comprises enlarging the code on the display screen of the television.
